(19) United States
(12) Patent Application Publication
(10) Pub. No.: US 2005/0000335 A1
(43) Pub. Date: Jan. 6, 2005

(54) System and method for cutting roofing shingles

(75) Inventors: John G. Freshwater, Bakersfield, CA (US); Olan Leitch, Bakersfield, CA (US)

Correspondence Address: HAYNES AND BOONE, LLP, 901 MAIN STREET, SUITE 3100, DALLAS, TX, 75202, US

(73) Assignee: Elk Premium Building Products, Inc., Dallas, TX (US)

(21) Appl. No.: 10/613,152

(22) Filed: Jul. 3, 2003

(51) Int. Cl. B26D 1/56

(52) U.S. Cl. 83/37; 83/346

(57) ABSTRACT

A system and method for cutting shingles according to which a plurality of cutting blades are mounted on the outer circumference of a cutting cylinder, and the cylinder is rotated with the blades engaging the sheet while effecting relative translational movement between the cylinder and the sheet so that eight unique shingles are cut from the sheet upon one rotation of the cylinder.

### BACKGROUND

This invention relates to a system and method for cutting individual objects, such as shingles, from a continuous sheet of material.

In the mass production of composition, or asphalt, roofing shingles, a cutting cylinder is often positioned to engage a continuous sheet of a composition material that forms the shingles. Cutting blades are provided on the outer circumference of the cutting cylinder and the continuous sheet of material is passed under the cylinder as it is rotated to cut the shingles. In order to produce an attractive pattern, shingles have been cut in a “dragon tooth” pattern. However, when dragon tooth patterns are cut, a lack of variance in shingle patterns result in a non-random appearance when the shingles are applied to a roof, resulting in a relatively unsightly patterned appearance when compared to individual wood shingles, and the like.

Therefore a system and method is needed to produce roofing shingles of the above type which are cut in a dragon tooth pattern yet increase both productivity and product appearance when compared to the techniques discussed above.

### BRIEF DESCRIPTION OF THE DRAWINGS

FIG. 1 is an isometric view depicting an embodiment of the system of the present invention.

FIG. 2 is an elevational view of eight shingles produced by the system of FIG. 1.

### DETAILED DESCRIPTION

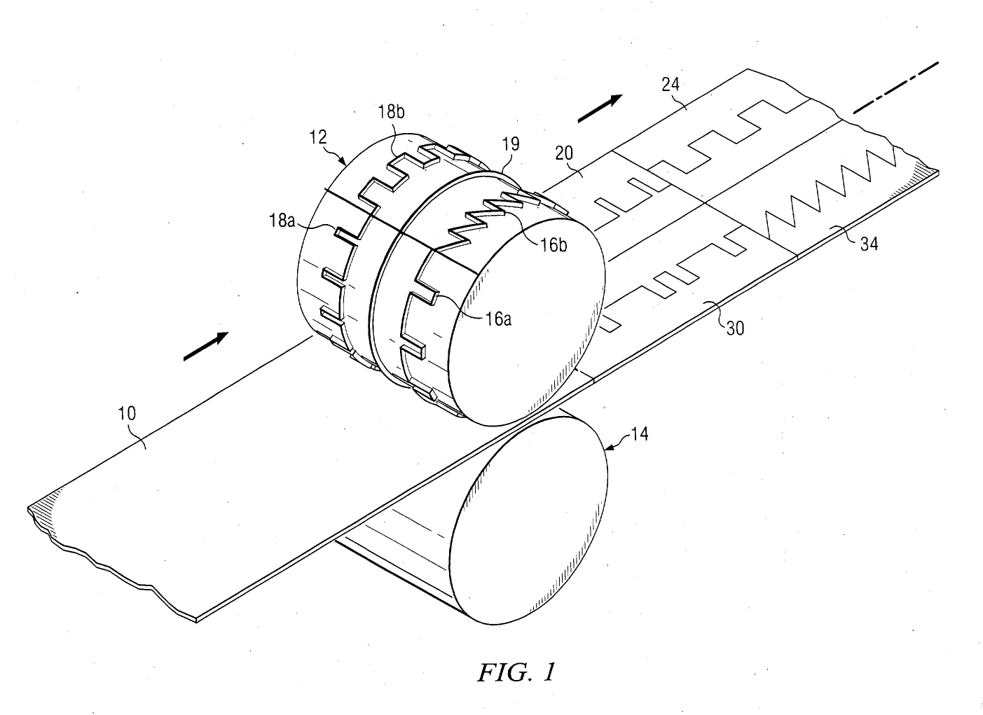

Referring to FIG. 1, the reference numeral 10 refers to a strip of material that is used to produce shingles in accordance with an embodiment of the invention. It is understood that the strip10 forms a portion of a continuous strip which is described in detail later. The strip 10 passes between two opposed cylinders 12 and 14 which are mounted for rotation in a conventional manner. One or both of the cylinders 12 or 14 is driven in any conventional manner to rotate the cylinders and drive the strip 10 in a longitudinal direction indicated by the arrows while being guided by edge guides, or the like (not shown), all in a conventional manner.

A cutting blade 16a is mounted on the outer circumference of the cylinder 12 and is adapted to cut the strip 10 when it passes between the cylinders 12 and 14. The cutting blade 16a extends for approximately one half the circumference of the cylinder, and a cutting blade 16b is also mounted on the outer circumference of the cylinder and extends from the cutting blade 16a around the remaining one half of the circumference of the cylinder.

A cutting blade 18a is also mounted on the outer circumference of the cylinder 12 and extends in a spaced parallel relationship to the blades 16a and 16b for approximately one half the circumference of the cylinder 12. A cutting blade 18b is also mounted on the outer circumference of the cylinder and extends from the cutting blade 18 and around the remaining one half of the circumference of the cylinder. A cutting blade 19 is also mounted on the outer circumference of the center portion of the cylinder 12 and extends around the entire circumference of the cylinder. The cutting blades 16a, 16b, 18a, 18b and 19 are mounted on the cylinder 12 in any conventional manner.

Although FIG. 1 is not necessarily to scale, it is understood that the circumference of the cylinder 12 is substantially equal to twice that of the length of each shingle to be cut, and the cutting blades 16a, 16b, 18a and 18b are configured to cut four different dragon tooth patterns in the strip 10 upon one rotation of the cylinder 12. Each dragon tooth pattern produces two shingles with complementary tabs and spaces between the tabs, which will be described. Therefore one rotation of the cylinder 12 produces eight unique shingles.

During the cutting of the above patterns by the blades 16a, 16b, 18a and 18b, the center cutting blade 19 cuts the strip 10 longitudinally to separate the patterns cut by the blades 16a and 16b from the patterns cut by the blades 18a and 18b. It is understood that an end cutter (not shown) can be provided downstream from, and in a spaced relation to, the cylinder 12 for making transverse cuts in the strip to cut the strips into predetermined lengths.

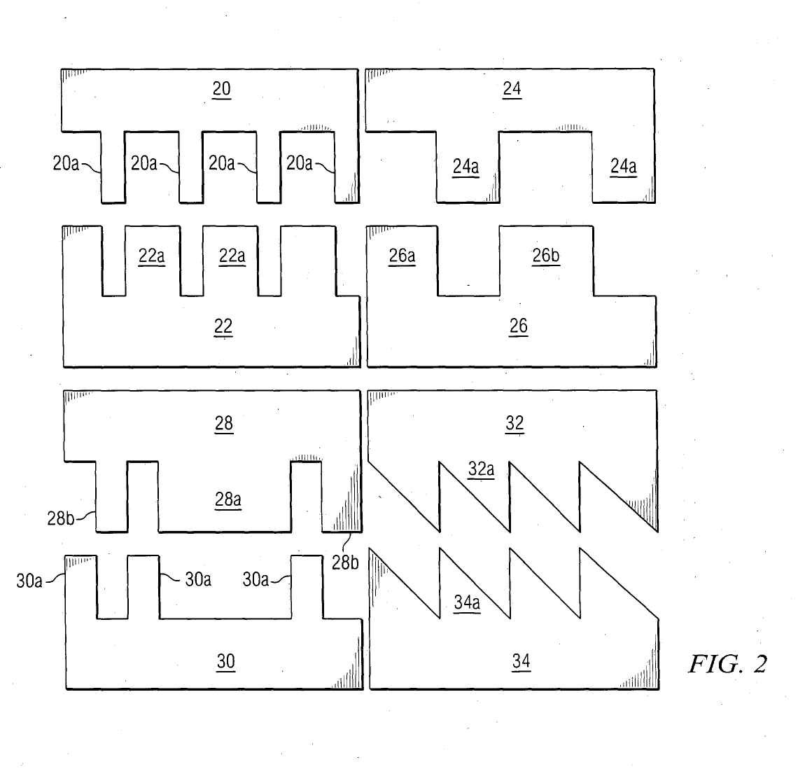

FIG. 2 shows examples of eight different shingles after being cut by the blades 16a, 16b, 18a, 18b and 19, and by the above end cutter in response to one rotation of the cylinder 12, with the shingles being shown spaced apart in the lateral and longitudinal directions. In particular, two shingles 20 and 22 are formed by the dragon tooth cut made by the blade 16a. The shingle 20 includes four relatively narrow rectangular tabs 20a, and the shingle 22 includes four relatively wide rectangular tabs 22a.

Two shingles 24 and 26 are formed by the dragon tooth cut made by the blade 16b. The dragon tooth pattern cut by the blade 16b is such that the shingle 24 includes two relatively wide rectangular tabs 24a which are wider than the wide tabs 22a of the shingle 22; while the shingle 26 includes a tab 26a that is wider than the tabs 24a and a tab 26b that is wider than the tab 26a.

Similarly, two shingles 28 and 30 are formed by the dragon tooth cut made by the blade 18a. The latter pattern is such that the shingle 28 includes a relatively wide rectangular tab 28a extending between two relatively narrow tabs 28b; while the shingle 30 is formed with three rectangular tabs 30a of the same width as the tabs 28b, with two of the tabs 30a being spaced apart as a result of cutting the tab 28a.

Two shingles 32 and 34 are formed by the dragon tooth cut made by the blade 18b. The dragon tooth pattern cut by the blade 18b is such that both shingles 32 and 34 include four triangularly shaped tabs 32a and 34a.

As a result of the above, one rotation of the cylinder 12 produces eight different shingles 20, 22, 24, 26, 28, 30, 32, and 34 all of which vary in appearance. Thus, when stacked and applied to a roof in sequence, a non-random, dimensional appearance is achieved rather than the unsightly patterned appearance of the prior art.

It should be emphasized that the above configurations of the shingles are for the purpose of example only, and that the patterns can vary considerably from those that are shown. For example, the sizes and numbers of the tabs, as well as their width, length, and/or shape can vary from tab-to-tab and/or from shingle-to-shingle. Also, the patterns cut by the blades are not limited to a dragon tooth pattern but may take other forms, such as saw tooth, etc.

According to a preferred method of applying the different patterned shingles 20, 22, 24, 26, 28, 30, 32, and 34 to a supporting structure to form a roof, the shingles are laid in accordance with the following equation:
C=L/N±3
where C is one of the course offsets, L is the length of each shingle, and N is the number of courses repeated during installation under the following conditions:
1. all of the shingles 20, 22, 24, 26, 28, 30, 32, and 34 have a tooth covering the area C±3″ from the left side of the shingle
2. all of the shingles 20, 22, 24, 26, 28, 30, 32, and 34 have a gap between teeth in the area C±3″ from the right side of the shingle, and
3. the sum of the offsets in the course repeat equal the shingle length.

This provides a random appearance and insures that all the seams between adjacent shingles 20, 22, 24, 26, 28, 30, 32, and 34 are covered for enhanced appearance and leak protection. Also, the above permits the shingles 20, 22, 24, 26, 28, 30, 32, and 34 to be applied using continuous offsets (e.g. 0. C, 2 C, 3 C . . . ) to obtain the same roof appearance as when the offsets repeat (e.g. 0, C, 2 C, 0, C, 2 C, etc.). Further, roofers can cut the shingles C inches from the right side of each shingle and never have to cut through a tooth and only one shingle needs to be cut every N courses when applying shingles of a rake edge which allows for easier application and less waste.

It is understood that the strip 10 may be formed in a conventional manner such as by applying one or two asphalt coatings to a base material made from a mat of organic felt, fiberglass, polyester, or a blended fiberglass/polyester, and applying one or two outer layers of mineral granules to the asphalt coating(s). Further details of the composition of the strip 10 and the lamination technique are disclosed in U.S. Pat. No. 5,369,929 which is assigned to the assignee of the present invention and which is incorporated by reference. It is also understood that one or more backing strips (not shown) can be laminated to the strip 10 before the resulting laminated strip is cut in the foregoing manner. The backing strip may be identical to the strip 10 or may be different from the latter strip.

It is understood that other variations may be made in the foregoing without departing from the scope of the invention. For example, the above-described relative movement between the cylinder 12 and the strip 10 can be achieved in other manners. Also, the spatial references, such as “over,” “under,” “longitudinal,” “lateral,” and the like, are for the purpose of illustration only and do not limit the specific orientation or location of the structure described above.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

1. A system for cutting shingles from a continuous sheet of material comprising:
a cylinder having a circumference substantially equal to twice the length of each shingle;
a cutting blade assembly extending around the outer surface of the cylinder and adapted to cut four different patterns in the strip with each pattern forming two shingles; and
means for rotating the cylinder with the blades engaging the sheet while effecting relative translational movement between the cylinder and the sheet so that eight shingles are cut from the sheet upon one rotation of the cylinder.

2. The system of claim 1 wherein the cutting blade assembly comprises two spaced parallel series of cutting blades, each series extending over the entire circumference of the cylinder.

3. The system of claim 2 wherein the cutting blade assembly comprises a first cutting blade mounted to the outer surface of the cylinder and extending over approximately one half of the circumference of the cylinder, a second blade mounted to the outer surface of the cylinder and extending from the first cutting blade and over approximately the other half of the circumference of the cylinder, a third cutting blade mounted to the outer surface of the cylinder and extending in a spaced parallel relationship to the first and second blades, and over approximately one half of the circumference of the cylinder, and a fourth blade mounted to the outer surface of the cylinder and extending from the third first cutting blade and over approximately the other half of the circumference of the cylinder.

4. The system of claim 3 wherein the cutting blade assembly comprises a fifth cutting blade extending over the circumference of the cylinder and adapted to make a continuous longitudinal cut down the center of the strip.

5. The system of claim 1 wherein the patterns are dragon tooth patterns.

6. The system of claim 1 wherein each series of cutting blades cuts a first pair of shingles, each shingle having a plurality of tabs extending in the spaces between adjacent tabs of the other shingle; and a second pair of shingles laterally spaced from the first pair, each shingle of the second pair of shingles having a plurality of tabs extending in the spaces between adjacent tabs of the other shingle of the second pair of shingles.

7. The system of claim 6 wherein the blades are configured so that at least a portion of the tabs of each shingle are different from the tabs of at least a portion of the other shingles.

8. The system of claim 6 wherein the blades are configured so that the tabs of each shingle are different from the tabs of the other shingles.

9. The system of claim 6 or 7 wherein the difference is in the shape of the tabs.

10. The system of claim 9 wherein the tabs vary in width and/or length.

11. The system of claim 6 wherein at least a portion of the tabs of the same shingle are different.

12. The system of claim 11 wherein the difference is in the shape of the tabs.

13. The system of claim 11 wherein the different tabs vary in width and/or length.

14. A method for cutting shingles from a continuous sheet of material comprising disposing cutting blades on the outer circumference of a cylinder, and rotating the cylinder with the blade engaging the sheet while effecting relative translational movement between the cylinder and the sheet so that eight shingles are cut from the sheet upon one rotation of the cylinder.

15. The method of claim 14 wherein the step of disposing comprises mounting a first series of cutting blades to the outer surface of the cylinder and extending over approximately one half of the circumference of the cylinder which corresponds to the length of a shingle, and mounting a second series of cutting blades to the outer surface of the cylinder and extending over approximately the other half of the circumference of the cylinder, each series of cutting blades being configured to cut two patterns in the strip in a manner so that each pattern forms two shingles.

16. The method of claim 15 further comprising mounting an additional cutting blade to the outer surface of the cylinder for making a continuous longitudinal cut down the center of the strip.

17. The method of claim 15 wherein each series of cutting blades includes two spaced parallel blades, each of which cuts a pattern in the strip.

18. The method of claim 17 wherein the patterns are dragon tooth patterns.

19. The method of claim 17 wherein each series of cutting blades cuts a first pair of shingles, each shingle having a plurality of tabs extending in the spaces between adjacent tabs of the other shingle; and a second pair of shingles laterally spaced from the first pair, each shingle of the second pair of shingles having a plurality of tabs extending in the spaces between adjacent tabs of the other shingle of the second pair of shingles.

20. The method of claim 19 further comprising configuring the blades so that at least a portion of the tabs of each shingle are different from the tabs of at least a portion of the other shingles.

21. The method of claim 19 further comprising configuring the blades so that the tabs of each shingle are different from the tabs of the other shingles.

22. The method of claim 20 or 21 wherein the difference is in the shape of the tabs.

23. The method of claim 20 or 21 wherein the tabs vary in width and/or length.

24. The method of claim 19 wherein at least a portion of the tabs of the same shingle are different.

25. The system of claim 24 wherein the difference is in the shape of the tabs.

26. The method of claim 24 wherein the different tabs vary in width and/or length.

27. A roof comprising a plurality of shingles laid on a support structure according to the following C=L/N±3
where C is one of the course offsets, L is the length of each shingle, and N is the number of courses repeated during installation.

28. The roof of claim 27 wherein all of the shingles have a tooth covering the area C±3″ from the left side of each shingle.

29. The roof of claim 28 wherein all of the shingles have a gap between teeth in the area C±3″ from the right side of each shingle.

30. The roof of claim 27 wherein the sum of the offsets in the course repeat equal the shingle length.
